(19) United States
(12) Patent Application Publication
(10) Pub. No.: US 2008/0192304 A1
(43) Pub. Date: Aug. 14, 2008

(54) Method And System For Facsimile Transmission

(76) Inventor: Robertus Hartono, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/674,674

(22) Filed: Feb. 14, 2007

(51) Int. Cl. H04N 1/00

(52) U.S. Cl. 358/434

(57) ABSTRACT

A system for facsimile transmission using an Internet Protocol (IP) telephone is disclosed. This system includes an analog facsimile machine connected to an interface device, which is in turn connected to an IP telephone. The interface device includes a two-to-four wire converter and a switch. The switch is coupled to the IP phone and to the two-to-four wire converter so as to enable switching between facsimile transmission and voice call.

### FIELD OF THE INVENTION

The present invention generally relates to methods and systems for facsimile transmission.

### BACKGROUND

In recent years, Internet Protocol (IP) telephones (“phones”) have become available. These specialized phones look like conventional phones, but instead of a conventional phone jack, they have an Ethernet connector. IP phones can be connected directly to an Ethernet port and have the hardware and software necessary onboard to handle IP calls. IP phones incorporates Voice over Internet Protocol (VoIP), which is a method of transmitting audio information in digital packets using Internet Protocol instead of transmitting audio signals to a conventional Public Switched Telephone Network (PSTN). VoIP enables voice communication over the Internet. As the result, public telephone lines are no longer necessary. Switching to IP phones may create a problem for offices and homes where conventional analog facsimile machines are widely used because analog facsimile machines are connected to public telephone lines. It may be desirable and more convenient for users to be able to send facsimile data over the network using an IP phone, instead of relying on a separate telephone line.

### SUMMARY

The present invention provides a system for facsimile transmission using an Internet Protocol (IP) telephone. This system includes an analog facsimile machine connected to an interface device, which is in turn connected to an IP telephone. The interface device includes a two-to-four wire converter and a switch. The switch is coupled to the IP phone and to the two-to-four wire converter so as to enable switching between facsimile transmission and voice call.

The objects and advantages of the present invention will become apparent from the detailed description when read in conjunction with the drawings.

### BRIEF DESCRIPTION OF THE DRAWINGS

FIG. 1 is a schematic diagram showing a system for transmitting facsimile data in accordance with an embodiment of the present invention.

FIG. 2 shows an exemplary circuitry for a two-to-four wire converter that is part of the system shown in FIG. 1.

FIGS. 3 and 4 show examples of hybrid circuits that are suitable for the two-to-four wire converter.

### DETAILED DESCRIPTION

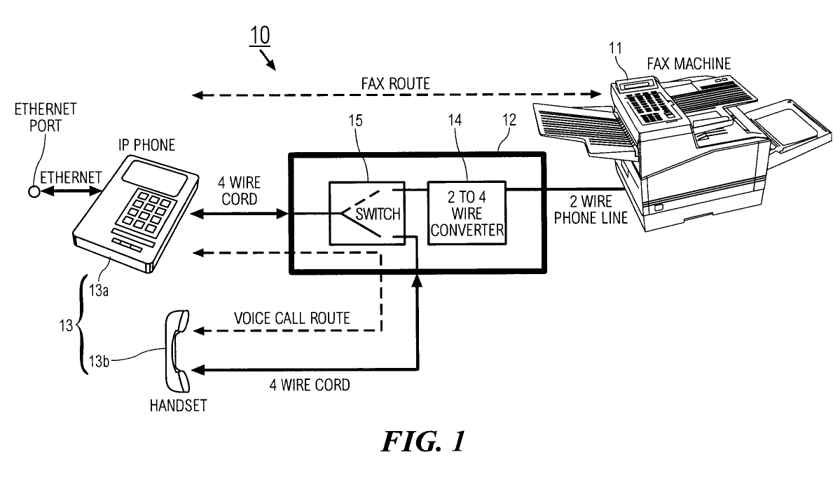

FIG. 1 shows a system 10 for transmitting facsimile (fax) data according to an embodiment of the present invention. Referring to FIG. 1, an analog facsimile (fax) machine 11 is connected to an interface device 12, which is in turn connected to an Internet Protocol (IP) phone 13. The IP phone 13 is connected to an Ethernet port, through which the IP phone 13 is connected directly to an IP network which is capable of transmitting IP protocols. The interface device 12 includes a two-to-four wire converter 14 and a switch 15. The fax machine 11 has a telephone line, which contains two wires (tip and ring), and these two wires are connected to the two-to-four wire converter 14. The two-to-four wire converter 14 converts the tip and ring wires into four wires—two for the microphone output and two for the speaker input of the IP phone 13. The switch 15 is coupled to the base 13a of IP phone 13 via a four-wire cord, to the handset 13b of the IP phone via another four-wire cord, and to the two-to-four wire converter 14 so as to enable switching between fax transmission and normal voice call. It should be understood by those in the art that the fax machine 11 may be a stand-alone fax machine or a multifunction imaging device with a fax function, such as a combination printer/scanner/fax machine.

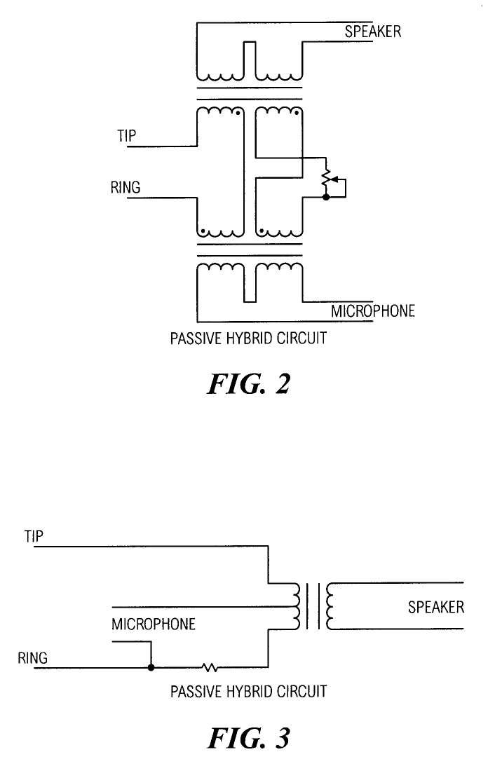

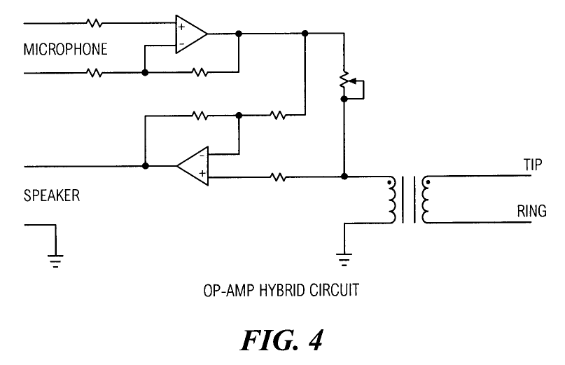

As an example, the two-to-four wire converter 14 may include a passive hybrid circuit as shown FIG. 2. Another example of a suitable hybrid circuit is the passive hybrid circuit shown in FIG. 3. However, the hybrid circuit is not limited to the passive hybrid circuits shown in FIGS. 2 and 3. As yet another example, the two-to-four wire converter 14 may include an op-amp hybrid circuit such as that shown in FIG. 4. It should be understood by those skilled in the art that other conventional hybrid circuits are possible.

By having the set-up shown in FIG. 1, the IP phone 13 can handle both voice calls and fax transmissions. To transmit fax data to a remote, conventional analog fax machine (not shown), the user places a document on the fax machine 11, picks up the handset 13b (the phone goes “off-hook”), and dials the desired fax number using the IP phone 13. The user then waits for an acceptance tone from the remote fax machine. Once the acceptance tone is heard, the user initiates fax transmission by executing a send command to the fax machine 11, e.g. pressing a “send” or “start” button on the fax machine 11. The IP phone 13 converts the analog data from the fax machine 11 into digital data for transmission over the IP network. The codec in the IP Phone enables the conversion from analog voice signal to digital data. The handset 13b remains off-hook during fax transmission. When the fax transmission is completed, the user hangs up the handset 13b.

To receive a fax communication, the user is required to pick up the handset 13b when the IP phone 13 rings due to an incoming fax communication. The user can distinguish an incoming fax call from a normal voice call upon hearing the CNG tone generated by the incoming fax call. Subsequently, the user can manually accept the incoming fax communication by executing a receive command to the fax machine 11, e.g. pressing on the “start” or “accept” button. Because the IP phone is connected to an IP network, the incoming fax data transported to the IP phone is in digital format. The IP phone 13 converts the digital data received to analog data, and the analog data is then transmitted to the fax machine 11 via the interface device 12. When the fax transmission is completed, the user hangs up the handset 13a.

While particular embodiments of the present invention have been described, it will be understood by those skilled in the art that modifications and substitutions can be made without departing from the scope of the invention as set forth in the following claims.

What is claimed is:

1. A system for facsimile transmission using an Internet Protocol (IP) telephone, said system comprising:
an IP telephone configured to be connected to an Ethernet port;
an analog facsimile machine;
an interface device comprising a two-to-four wire converter and a switch,
wherein said two-to-four wire converter is connected to the facsimile machine, and said switch is connected to the IP phone and to the two-to-four wire converter so as to enable switching between facsimile transmission and voice call.

2. The system of claim 1, wherein said two-to-four wire converter comprises a hybrid circuit.

3. The system of claim 2, wherein the hybrid circuit is a passive hybrid circuit.

4. The system of claim 2, wherein the hybrid circuit is an op-amp hybrid circuit.

5. A method for transmitting facsimile data using an Internet Protocol (IP) telephone, said method comprising:
providing an interface device comprising a two-to-four wire converter coupled to a switch;
connecting said two-to-four wire converter to an analog facsimile machine;
connecting said switch to an IP telephone, which is in turn connected to an IP network, said switch being configured to enable switching between facsimile transmission and voice call;
dialing a destination facsimile number of a remote facsimile machine using the IP telephone;
receiving an acceptance communication from the remote facsimile machine; and
executing a send command to the analog facsimile machine to transmit facsimile data.
